(19) United States
(12) Patent Application Publication
(10) Pub. No.: US 2020/0327997 A1
(43) Pub. Date: Oct. 15, 2020

(54) FAULT REPORTING DEVICE, FACILITY MANAGEMENT ARRANGEMENT, METHOD, COMPUTER PROGRAM AND MACHINE-READABLE STORAGE MEDIUM

(71) Applicant: Robert Bosch GmbH, Stuttgart (DE)

(72) Inventors: Holger Behrens, Muenchen (DE); Sara Scatasta, Tamm (DE)

(21) Appl. No.: 16/845,150

(22) Filed: Apr. 10, 2020

(30) Foreign Application Priority Data
Apr. 11, 2019 (DE) 10 2019 205 181.2

(51) Int. Cl. G16Y 40/10; G16Y 10/80; G16Y 20/30; G16Y 40/50; G05B 23/02

(52) U.S. Cl. CPC G16Y 40/10; G16Y 10/80; G05B 23/0218; G16Y 40/50; G16Y 20/30

(57) ABSTRACT

A fault reporting device 8 for reporting a fault to a facility management arrangement 9, having a location module, wherein the location module is formed to determine a location position X(t) of the fault reporting device 8, having a position determining module, wherein the position determining module is formed to identify a fault position in a surrounding area of the location position X(t), having a transmission module for wirelessly transmitting a fault report, wherein the fault report comprises the fault position and fault information 12.

### BACKGROUND OF THE INVENTION

A fault reporting device for reporting a fault to a facility management arrangement is provided so that a user can report a fault related to a piece of furniture, a building or other objects, for example, to a responsible department.

Faults relating to a building or to devices, for example leaking faucets or windows that do not close properly, in varied environments and in particular in businesses are reported to a central and/or a responsible facility management representative. Such reporting can traditionally be carried out by telephone or via a written notice, alternatively there are web applications via which a user can inform the responsible members of staff and/or service in writing that “the window in room 123, 3^{rd} floor does not close”, for example. It is often the case that the details provided by the member of staff are incomplete, inaccurate or false. For example, members of staff and/or users confuse cardinal points, for example an east staircase with a west staircase, and/or inaccurately define the location of the fault. In particular, it is often difficult for contracted and/or new personnel to be able to report errors and/or faults in a correct manner.

Document DE 10 2017 210 374 A1, which possibly represents the closest prior art, describes a fire detector device as an alarm annunciator. The fire detector device comprises a sensor system for detecting a fire based on detected environment variables. The alarm annunciator comprises a wireless transmitter for transmitting radio signals, in order to transmit broadcast messages to a further device by means of the radio signals, wherein the broadcast messages comprise the identification of the alarm annunciator.

### SUMMARY OF THE INVENTION

A fault reporting device for reporting a fault is disclosed. Furthermore, a facility management arrangement, a method for reporting a fault, is disclosed. A computer program for carrying out the method is further disclosed and a machine-readable storage medium with the computer program.

The invention relates to a fault reporting device for reporting a fault. The fault reporting device is preferably a mobile device, for example a mobile apparatus. In particular, mobile means portable and/or a pocket-sized apparatus which can be carried by the user. For example, the fault reporting device can be formed as a smart device, for example a smartphone or a tablet. In particular, the fault reporting device can also be formed as a computer unit, laptop or personal computer, wherein a web application is provided, for example. In particular, the fault reporting device can also be formed as a web application or as a general application. A fault in the surrounding area of the fault reporting device can be reported by means of the fault reporting device. The fault is a mechanical, electrical or infrastructural fault, for example. Examples of faults are damage to pieces of furniture, defective lightbulbs or windows that do not close properly. In particular, the fault is transmitted to a facility management arrangement. The facility management arrangement can be a server, a further fault reporting device or a central receiving center. In particular, the facility management arrangement collects the faults and serves to pass on the faults to mechanics, tradespeople and/or caretakers. In particular, the facility management arrangement is a central arrangement which preferably receives and collects all and/or many faults. It is particularly preferable that different types and/or natures of faults can be reported by means of the fault reporting device. A facility management arrangement is intended to be understood to mean in particular an arrangement for property management and/or an arrangement for object support.

The fault reporting device has a location module. The location module can be formed as a software module or as a hardware module. A location position of the fault reporting device is determined by means of the location module. Locating relates in particular to identifying the position in a building, specifically within and/or on a floor plan. The location position is in particular a coordinate in two or three dimensions. The location position can in particular comprise information regarding the room, floor and/or building. For example, the location position is an indication of a floor number, a room number and a position within the room. Locating and/or identifying the location position can be based on GPS localization, for example. Furthermore, determining the location position and/or location can be based on locating via Bluetooth, Wi-Fi, UWB, VLC (Visible Light Communication), SLAM (Simultaneous Localization and Mapping) or can take place by means of scanning a QR code. The location position corresponds in particular to the current position of the location module and/or the fault reporting device.

In particular, the location module serves an indoor localization (interior localization) inside a building and/or room or section of a room.

The fault reporting device has a position determining module which can be formed as a software module or as a hardware module. In particular, the position determining module can form a common module with the location module. The position determining module is formed to identify a fault position based on the location position. The fault position is arranged and/or to be identified in a surrounding area of the location position. For example, the surrounding area can be a floor on which the location position which is determined by the location module is arranged. In particular, the fault position and the location position are dependent on one another. The fault position is preferably the position at which the fault which is to be reported is located. The fault position can be a point in the surrounding area of the location position, alternatively and/or additionally, the fault position is a section of the surrounding area of the location position.

The fault reporting device comprises a transmission module for wirelessly transmitting a fault report. The transmission module can be formed to transmit by means of Wi-Fi, Bluetooth, infrared, radio or other modes of transmission. The fault report is formed as a data report and/or a data set, for example. In particular, the transmission module is wireless and/or can be coupled with the facility management arrangement in a data-technical manner. The fault report includes the fault position and fault information. The fault information can comprise several pieces of information and/or data and, in particular, describes the fault. The fault position is the position belonging to the fault which has been identified in particular by means of the position determining module. Furthermore, the fault report can comprise further information, for example the location position, a report ID and/or any additional information. In particular, the fault report describes a data fusion of the fault position and fault information. The facility management arrangement is thus provided with the fault reports so that the control center, a caretaker or responsible agent are provided with the essential information regarding the fault, in particular the fault position and the fault information, in a precise and correct manner.

One consideration of the invention is to provide a fault reporting device which combines a locating functionality with a fault reporting functionality. The fault is clearly assigned to the respective location so that uninformed and/or new users and/or members of staff can also report faults in a precise and correct manner, for example. In particular, the faults are thus reported in a complete and accurate manner. Inaccuracies in the report of the fault can therefore be avoided, such that unnecessary queries when reporting can be avoided, and the faults can be fixed effectively and quickly.

It is particularly preferable that the fault reporting device has an input module and a display. In particular, the input module and display module can form a common module, for example a touchscreen. The display is formed to display a map. The map shows and/or describes a surrounding area of the location position. The map can be formed as a floor plan. The map is a true-to-scale representation of the floor on which the person reporting and/or the fault reporting device is located, for example. In particular, provision can be made for the current location position to be delineated and/or displayed on the display in the map. The map can be a two-dimensional or three-dimensional map of the surrounding area.

The input module is formed such that a user can identify a selection position based on the displayed map. The selection and/or the identification of the selection position can be formed as a numerical, alphanumerical or graphical input. The user can input the selection position by means of a mouse or a keyboard, for example. The map is structured in a matrix-like manner, in particular checkered, for example, so that the user can indicate the cell, cell number and/or column number in which they would like to identify the location position. Alternatively and/or additionally, the user can, for example by means of the input module, graphically identify and/or delineate the selection position directly in the displayed map, for example by means of the touchscreen and/or by selecting with a mouse or other input means. In particular, identification can also take place by delineating and/or marking a point, or rather a section or an area.

The position determining module is provided with the selection position. Specifically, the position determining module is formed to identify the fault position based on the selection position. The position determining module is formed to accept the selection position as the fault position, for example. This configuration is based on the consideration that a user can intuitively identify the fault position in a map and/or based on their current location or rather their location position. In this way, input errors and/or position errors are in particular avoided.

A further configuration of the invention makes provision for the additional data to comprise an orientation of the fault reporting device. For example, the orientation can comprise a viewing direction and/or an orientation of the fault reporting device at the current time. The orientation is provided in the form of an arrow, for example, so that the user can orientate themselves more easily and more intuitively in the surrounding area, and thus a precise indication and/or positioning of the fault is made possible.

Moreover, it is possible that the additional data comprise accuracy information regarding the location position. For example, the accuracy information is displayed as a scale, alternatively and/or additionally, the accuracy information can be given as a circle around the current position, on the basis of which the user can assess how accurate the positioning of their location position currently is, such that they can take into account and/or calculate possible errors and tolerances.

In particular, it is preferable that the selection position can be graphically identified in the map by means of the input module. The identification takes place by marking a point and/or delineating and/or cropping the map, for example. Identification by delineating and/or marking can take place by identifying support points and/or a boundary with support points, for example, alternatively, an AI-based identification can take place, for example, in particular as a lasso functionality.

Provision is optionally made for the map to comprise and/or display objects of interest. Objects of interest can depict pieces of furniture, infrastructure objects and/or custom objects, for example. The map may already include the objects of interest, alternatively, the user can add objects of interest independently, for example by selecting from a selection menu, for example a drop-down menu, and the positioning within the map. For example, a user can add and position an object, in particular an object of interest, based on the geometry of the room and their currently displayed position, in order to define the object as a fault or to make it easier for the caretaker or personnel to find the fault. In particular, it is possible that an and/or the object of interest can be identified as the selection position by means of the input module. For example, a user can identify a window, a chair or a desk as the object of interest and the selection position so that the subsequent caretaker or fitter can accurately localize and define the object which is to be repaired. This configuration is based on the consideration of providing a fault reporting device which makes it possible to indicate faults in an improved manner.

One configuration of the invention makes provision for the fault reporting device to comprise an additional data module. The additional data module is formed to provide additional data for the surrounding area of the location position. Additional data can be data which are dependent on the location position, for example, in particular also data which are dependent on the user and the location position. Furthermore, provision is made for the additional data to be delineated and/or displayed on the displayed map, for example. The additional data are temporary data which are not permanently included in the surrounding area and/or the map, for example, and/or they can alter over time and depending on the location or person.

The additional data comprise faults and/or fault reports which have already been recorded and/or reported, for example. The fault reporting device is provided with faults and/or fault reports which have already been reported, for example, wherein the faults which have already been reported are displayed on the map so that the user does not report one fault again, for example. Provision can further be made for additional data which describe faults and/or fault reports which have already been recorded to be able to be supplemented and/or expanded, for example a user can prioritize or supplement with details a fault which has already been reported. This configuration is based on the consideration of providing an efficient fault reporting device which, on the one hand, avoids multiple reports and/or, on the other hand, however, can also prioritize, favor and/or alter faults which have already been reported.

It is particularly preferable that the fault information comprises information regarding the type of fault. The type of fault can generate information which defines the fault in more detail, for example if it is a mechanical, electrical or installation-related fault. Furthermore, the type of fault can be even more specific, for example if it is a cracked windowpane or a leaking faucet. The type of fault can be a predefined type of fault and/or selectable from a limited selection, alternatively, the type of fault is one which can be freely formulated.

In particular, provision is made for the type of fault, partial or all fault information to be able to be selected and/or identified by means of the input module. For example, the user can select and/or identify the type of fault from a drop-down menu so that the subsequent agents can effectively preselect and/or assign to agents. In particular, partial or all fault information can be selected and/or identified. It is further particularly preferable that the type of fault can be selected from a drop-down menu, wherein further details and/or additional information regarding the type of fault can be deposited. For example, the user can select prefabricated and/or predefined types of faults and supplement them with their own details and/or descriptions, such that a more effective process is possible.

In particular, the fault reporting device is formed as an indoor device and/or formed for locating and/or for determining the position in enclosed rooms. In particular, provision can be made for the fault reporting device to also be able to be operated to determine the position in rooms shielded from radiation relative to the surrounding area, and/or the position can be determined in this way. For example, the fault reporting device can also be operated in a basement which would be shielded from GPS signals, for example by locating by means of Wi-Fi or other indoor locating options.

A further subject of the invention is a facility management arrangement having at least one fault reporting device and/or for communicating with the fault reporting device. The facility management arrangement is formed as a control center, for example, which can be coupled with the fault reporting devices in a data-technical manner, in particular wirelessly. The fault reporting devices are formed to report faults to the facility management arrangement, in particular in the manner described previously using the fault reporting devices. The facility management arrangement is formed to receive, collect and/or to display the fault report.

A further subject of the invention is a method for reporting a fault. The method makes provision for the current position of what is to be reported to be determined and/or the position or what has been reported to be located. Locating and/or identifying the position serves to determine the location position. A fault position is identified in the surrounding area of the location position, based on the determined location position. Identifying the fault position can be automated, alternatively, the fault position can be selected and/or identified by the user, for example through selection in a map, wherein the map shows the surrounding area of the location position. Furthermore, a fault report is transmitted, wherein the fault report describes and/or characterizes the fault. The fault report comprises the fault position and fault information. The method is based on the consideration of providing a way to report a fault in which a complete report of the fault is made and, in particular, it is correct, in particular with respect to the location of the fault.

A further subject of the invention is a computer program for carrying out the method if the method is being performed on a computer, a processor and/or a fault reporting device, in particular as described previously.

### BRIEF DESCRIPTION OF THE DRAWINGS

A further subject of the invention is a machine-readable storage medium, for example a disk, a CD-ROM, a hard drive and/or a USB stick. The computer program is stored on the machine-readable storage medium, as described previously. Preferred and/or advantageous embodiments of the invention will be evident from the enclosed figures and their description. In the drawings:

FIG. 1 shows an example of use of a fault reporting device;

FIG. 2 shows exemplary displays of a fault reporting device;

FIGS. 3 and 4 show detail cutouts of displayed maps.

### DETAILED DESCRIPTION

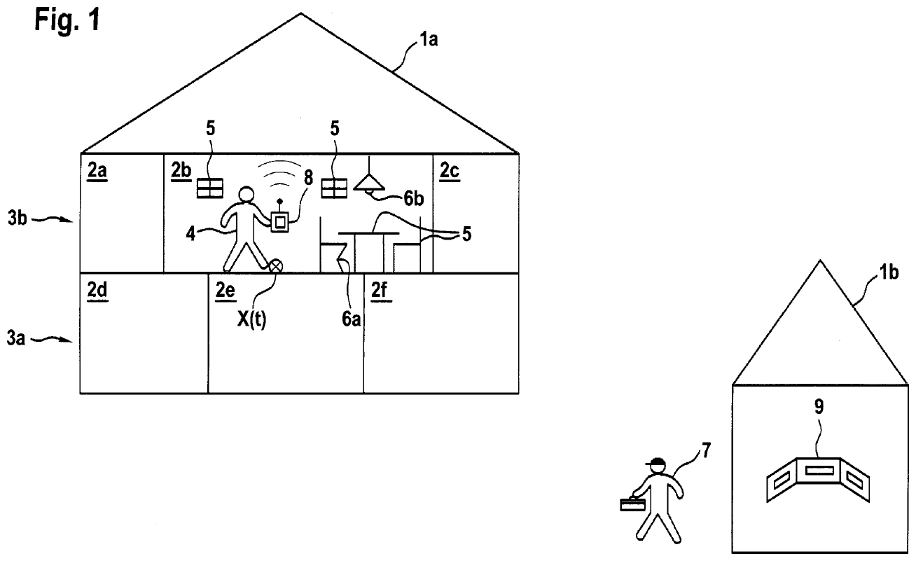

FIG. 1 schematically shows two buildings la and lb. Building la is an office building, for example, and comprises multiple rooms 2a-2f. Rooms 2a-2f are spread over multiple floors 3a and 3b. In particular, rooms 2a-2f can be shielded from electromagnetic rays from the outside, for example if a room is arranged in a basement.

A user 4 is arranged in building 1a. The user 4 can preferably move freely in the building and/or the rooms 2a-2f. The user 4 is a member of staff, for example. In this embodiment, the user 4 is arranged in room 2b. Room 2b is the office of this member of staff, for example. Furthermore, there are objects of interest 5 located in room 2b, wherein these objects of interest 5 represent pieces of furniture such as tables, chairs and/or windows. The user 4 would like to report faults 6a and 6b in this room. Fault 6a is a broken chair leg, for example, wherein fault 6b represents a defective lightbulb in a light. Faults 6a and 6b are fixed by another member of staff or an external company by a tradesperson 7. For this purpose, the member of staff 4 must inform the tradesperson 7 of the faults 6a and 6b in a precise and concrete manner.

In this respect, the user 4 has a fault reporting device 8. The fault reporting device 8 is a mobile apparatus, for example in the form of a smartphone or tablet. The member of staff 4 can transmit the faults 6a and 6b to a facility management arrangement 9 by means of the fault reporting device 8. The facility management arrangement 9 is arranged in building lb and/or with an external company and is a computer unit, for example. The tradesperson 7 is provided with and/or informed of the faults via the facility management arrangement 9. The facility management arrangement 9 serves as a collection point for received and/or reported faults, for example.

The fault reporting device 8 is formed to determine a location position X(t). The location position X(t) is determined as the current position of the user 4 by means of a position determining module. The location position X(t) is temporally variable, depending on where the user 4 with the fault reporting device 8 is currently located. The location position comprises the room number, the floor and/or relative or absolute position details in building la, for example. Determining the location position takes place by means of GPS localization, by means of Wi-Fi localization or other radio-based localization options, for example.

The fault reporting device 8 is formed to transmit the fault to the facility management arrangement 9 in the form of a fault report, wherein the fault report comprises fault information regarding the faults 6a and/or 6b, as well as a fault position. The fault position is identified and/or determined by the fault reporting device and/or by the user 4 by means of the fault reporting device, based on the location position X(t). In this way, the facility management arrangement 9 and/or the tradesperson 7 is provided with a fault report which includes the precise and/or in particular rarely incorrect fault position and additionally has information regarding the fault. In particular, provision can be made for the tradesperson 7 to possess a navigation apparatus and/or a fault reporting device. The tradesperson 7 can be navigated to the location position X(t) and/or to the fault position of the reported fault, in particular can be navigated within the building la, the rooms 2a-2f and/or the floors 3a and 3b, by means of this navigation apparatus and/or this fault reporting device, for example.

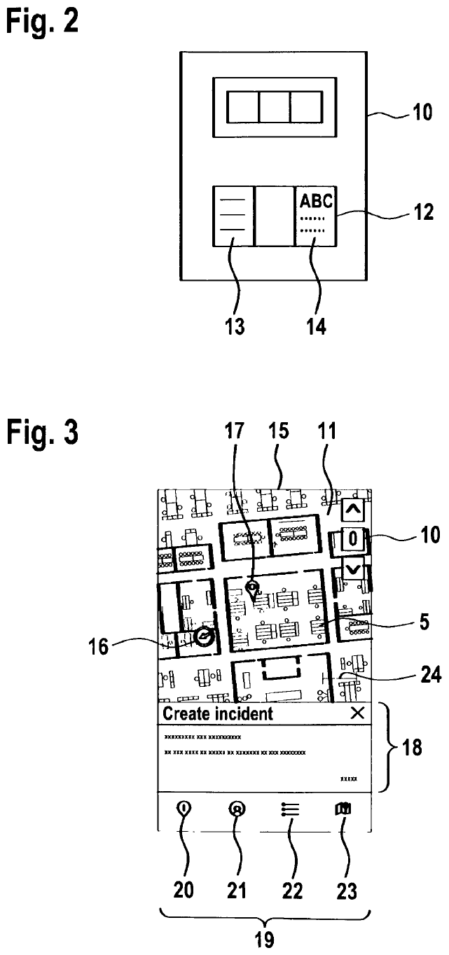

FIG. 2 shows a display 10 of a fault reporting device 8 by way of example. The display 10 is formed as a display and in particular as a touchscreen, for example. The display 10 can also be directly used as an input module by means of the touchscreen properties of the display 10. The display 10 is formed to display a map 11. The map 11 is a 2D map and/or a floor plan, for example. The map 11 which is displayed by the display 10 shows a map of the surrounding area of the location position. The display and/or the fault reporting device is formed to load and/or display the appropriate map based on the determined location position X(t), for example. The displayed map 11 is the map and/or the floor plan of the floor 3 on which the user 4 with the fault reporting device 8 is located, for example. Based on the map 11, the user 4 can orientate themselves and localize and/or identify the fault using this map.

Furthermore, the fault report can be identified and/or specified by fault information 12 by means of the display 10 and/or the input module. In this respect, the user can identify the nature of the fault and/or the type of fault, for example. The nature of the fault and/or the type of fault can be selected from a selection menu 13, for example, in which common and/or normal natures of faults and/or types of faults are suggested. Examples of natures of faults and/or types of faults are defective lightbulbs, defective furniture and/or faucets, for example. Furthermore, the nature of the fault and/or the type of fault can be formulated in a more general manner, for example it is a gas/water installation error, an electrical error or a mechanical error.

The user 4 can in particular identify the fault position. This identification can take place by selection and/or identification within the map, for example, alternatively, the identification can take place by numerical input, for example by dividing the map 11 into squares, wherein the user 4 can then input the corresponding squares and/or area.

Furthermore, additional information for the fault report can be deposited by means of the display and/or by means of the input module, wherein this additional information can be input into an additional information area 14. This additional information can comprise data which serve to identify the person reporting, for example, make further information regarding the fault 6 possible which is helpful to the tradesperson 7, for example, and/or a timestamp. The fault report can be and/or is then transmitted from the fault reporting device 8 and comprises the fault position, the type of fault and/or the nature of the fault, as well as additional information.

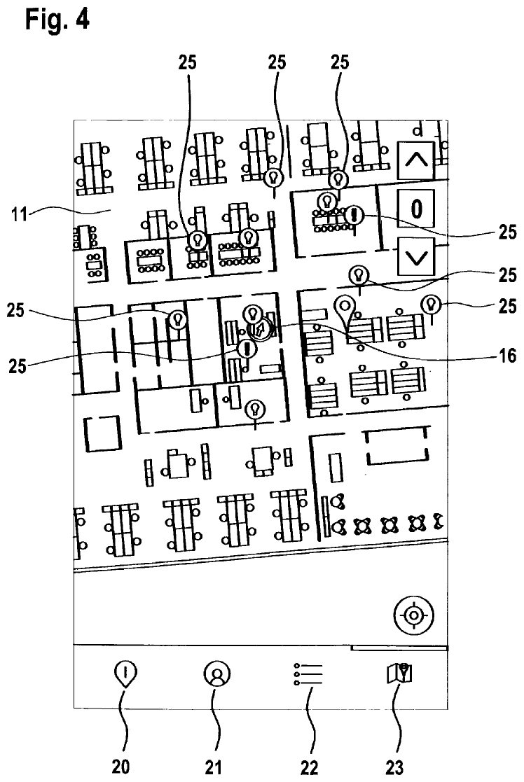

FIG. 3 shows a detail view of a display 10. The display 10 shows a map 11 as a floor plan, wherein the walls 15 are delineated and also objects of interest 5 such as tables and chairs, for example. Furthermore, the current location position is delineated by means of a location marker 16. The location marker 16 further comprises orientation information, for example the viewing direction and/or the holding direction of the fault reporting device 8, wherein here it is displayed in the form of an arrow direction. Furthermore, the fault position is displayed in the map 11, wherein here the fault position is delineated as a fault position marking 17. This marking can mark the fault and/or the fault position with a pin, for example. The fault position and/or the fault position marking 17 can be identified by directly touching the display 11 at the corresponding position in the map 11, for example.

Furthermore, a display menu 18 is displayed in which the user 4 can identify and/or input entries and/or details regarding the fault 6. Basic controls of the fault reporting device 8 can be adjusted in a help menu and/or global menu 19, for example a help menu 20 can be loaded, profile data 21 can be loaded, a list display 22 can be loaded or the map display 23 can be activated.

Furthermore, a scale 24 is displayed in the display 10, so that the user 4 can assess positions and/or distances in order to be able to better identify and/or gauge the fault position. In particular, an object of interest 5 can also be directly selected as the fault position, for example a specific table or chair.

FIG. 4 shows a further example of a displayed map 11 on the fault reporting device 8. However, in this map 11, which is formed substantially similar and/or identical to the map 11 from FIG. 3, faults 6 which have already been reported are delineated. The faults 6 are delineated by fault markings 25. The fault markings 25 indicate the position and/or the fault position of the faults 6 which have already been reported, they further include a symbol and/or a marking which reflects the nature of the fault 6 and/or the type of fault. For example, symbols of this type can be thermometers for defective heaters, lightbulbs for defective lightbulbs and/or other symbols for other faults.

In particular, the fault reporting device makes it possible for the user to not have to report the fault 6 from the direct location and/or fault position, but instead can submit and/or report this fault report from another location, in particular the surrounding area. For example, the user 4 discovers that a faucet in a bathroom is defective, the user 4 can therefore also report the defective faucet from their office by means of the proposed fault reporting device 8 and does not have to distribute the report directly from the bathroom. For this purpose, the user 4 can return to their office, for example, and, based on the displayed map and their position, can mark the faucet as a fault in the displayed room in the map and submit the report.

1. A fault reporting device (8) for reporting a fault to a facility management arrangement (9), the fault reporting device (8) comprising:
a location module configured to determine a location position (X(t)) of the fault reporting device (8),
a position determining module configured to identify a fault position in a surrounding area of the location position (X(t)), and
a transmission module for wirelessly transmitting a fault report, wherein the fault report comprises the fault position and fault information (12).

2. The fault reporting device (8) according to claim 1, further comprising an input module and a display (10) for displaying a map (11) of the surrounding area of the location position (X(t)), wherein a selection position can be identified by means of the input module based on the displayed map (11), wherein the position determining module is formed to identify the selection position as the fault position.

3. The fault reporting device (8) according to claim 2, wherein the selection position can be identified graphically in the displayed map (11) by means of the input module.

4. The fault reporting device (8) according to claim 2, wherein the displayed map (11) comprises objects of interest (5), wherein an object of interest (5) can be identified as the selection position by means of the input module.

5. The fault reporting device (8) according to claim 1, further comprising an additional data module, wherein the additional data is formed to provide the surrounding area of the location position X(t) with additional data and to display the additional data on the display (10) in the displayed map (11).

6. The fault reporting device (8) according to claim 5, wherein the additional data comprises faults (6) which have already been recorded.

7. The fault reporting device (8) according to claim 5, wherein the additional data comprise an orientation of the fault reporting device (8).

8. The fault reporting device (8) according to claim 5, wherein the additional data comprise accuracy information regarding the location position (X(t)).

9. The fault reporting device (8) according to claim 1, wherein the fault information (12) comprises information regarding the type of fault.

10. The fault reporting device (8) according to claim 9, wherein the type of fault can be selected via the input module.

11. The fault reporting device (8) according to claim 1, wherein the fault reporting device (8) comprises an indoor device.

12. A facility management arrangement (9) having at least one fault reporting device (8) according to claim 1.

13. A method for reporting a fault (6), wherein the one locating takes place in order to determine a location position (X(t)), wherein a fault position is identified in the surrounding area of the location position (X(t)) based on the location position (X(t)), wherein a fault report is transmitted, wherein the fault report comprises the fault position.

15. A non-transitory, computer-readable medium containing instruction which when executed by a computer cause the computer to
determine a location position (X(t)) of the fault reporting device (8) via a location module,
identify a fault position in a surrounding area of the location position (X(t)) via a position determining module configured to, and
transmit a fault report comprising the fault position and fault information via a wireless transmission module.
